(19) United States
(12) Patent Application Publication
(10) Pub. No.: US 2024/0392977 A1
(43) Pub. Date: Nov. 28, 2024

(54) AIR CIRCULATING DEVICE HAVING HEAT EXCHANGE ELEMENT FOR DUST COLLECTION

(71) Applicant: CENDORI CO., LTD., Seoul (KR)

(72) Inventor: Moon Soo PARK, Gwangju (KR)

(21) Appl. No.: 18/795,209

(22) Filed: Aug. 6, 2024

Related U.S. Application Data
(63) Continuation of application No. PCT/KR2023/001927, filed on Feb. 9, 2023.

(30) Foreign Application Priority Data
Feb. 10, 2022 (KR) 10-2022-0017503

(51) Int. Cl. F24F 1/18; F24F 8/30

(52) U.S. Cl. CPC F24F 1/18; F24F 8/30

(57) ABSTRACT

Provided is directed to the provision of an air circulating device having a heat exchange element for dust collection having the heat exchange element therein and including a case that is divided into an outdoor air inflow space, an indoor air discharge space, an outdoor air discharge space, and an indoor air inflow space centered on the heat exchange element, in which the heat transfer plates or spacers of the heat exchange element are made of a conductive material, the heat transfer plates or spacers are electrically connected to the top or bottom plate and frames of the heat exchange element, and an electrode for generating negative or positive charges is connected to any one of the top or bottom plate and the frames. An effect of the present invention is to provide a considerably useful invention that can remove dust more effectively.

### TECHNICAL FIELD

The present invention relates to an air circulating device having a heat exchange element for dust collection, and more specifically, to an air circulating device in which a dust removal function is added to a heat exchange element for heat exchange inside the air circulating device.

### BACKGROUND ART

In general, air circulating devices for changing indoor air are intended to cause indoor air to flow outdoors or outdoor air to flow indoors, and are installed in various facilities such as schools, hospitals, kitchens, and subway stations as well as general houses and apartments.

That is, in a conventional air circulating device,
an outdoor air inlet configured to suck in outdoor air and an indoor air outlet configured to discharge indoor air to the outside are formed on the outside of a case, and an outdoor air outlet configured to discharge outdoor air to the inside and an indoor air inlet configured to suck in indoor air are formed on the inside of the case.

Furthermore, a heat exchange element is installed inside the case. The heat exchange element is a tool used in an air conditioning device to enable heat exchange between inflow air and outflow air, thereby reducing energy consumption. The air conditioning device refers to a device that adjusts a specific indoor space to the temperature, humidity, and airflow distribution suitable for human activities and, at the same time, removes dust, etc. in the air.

The conventional heat exchange element is formed in a structure in which flat heat transfer plates (liners) and spacers (corrugated boards) each having a corrugated section are alternately stacked at predetermined intervals. The spacers are respectively arranged in the spaces between the plurality of heat transfer plates. The plurality of spacers are repeatedly arranged such that air paths are formed in directions perpendicular to each other. In this case, the heat transfer plates (liners) and the spacers (corrugated boards) each having a corrugated section are made of a paper material.

Accordingly, outdoor air passes through the spacers in one direction and indoor air passes through the spacers in the other direction. In this case, the outdoor air and the indoor air are prevented from being directly mixed by the heat transfer plates, and heat exchange between the outdoor air and the indoor air is performed to minimize the temperature difference between the outdoor air and the indoor air, thereby minimizing energy loss.

Meanwhile, heat exchange elements having this structure do not have means capable of removing dust on their own, so that filters are installed in the outdoor air inlet and indoor air outlet and remove dust.

However, in order to capture fine dust, high-performance filters or multiple filters need to be employed. In this case, when high-performance filters or multiple filters are employed, air flow becomes worse, which ultimately reduces ventilation efficiency.

As described above, the conventional heat exchange elements only consider a means for improving the heat transfer effect between indoor air and outdoor air, but do not have a structure that enables dust removal, so that the conventional heat exchange elements have the disadvantage of being inefficient.

### PRIOR ART LITERATURE

1. Korean Patent No. 10-2107769

### DISCLOSURE

### Technical Problem

An object of the present invention is to provide a heat exchange element capable of removing dust more effectively by providing a structure that enables the removal of fine dust in the heat exchange element for heat exchange inside an air circulating device.

### Technical Solution

An air circulating device according to an embodiment of the present invention for achieving the above-described object has a heat exchange element therein and includes a case that is divided into an outdoor air inflow space, an indoor air discharge space, an outdoor air discharge space, and an indoor air inflow space centered on the heat exchange element. The heat transfer plates or spacers of the heat exchange element are made of a conductive material, and the heat transfer plates or spacers are electrically connected to the top or bottom plate and frames of the heat exchange element. An electrode for generating negative or positive charges is connected to any one of the top or bottom plate and the frames.

In the present invention, the charge generator is provided on one side of the heat exchange element, and an electrode for generating charges having a polarity opposite to that of the charges generated by the charge generator is connected to the top or bottom plate and frames of the heat exchange element.

### Advantageous Effects

An effect of the present invention described above is to provide the considerably useful invention that can remove dust more effectively by providing the structure that enables the removal of fine dust in the heat exchange element for heat exchange inside the air circulating device.

### DESCRIPTION OF DRAWINGS

FIG. 1 is a sectional view of an air circulating device according to an embodiment of the present invention;

FIG. 2 is an exploded perspective view of a heat exchange element in the present invention;

FIG. 3 is an assembled perspective view of FIG. 2;

FIG. 4 is a sectional view showing the structures of the heat transfer plate and spacer of a heat exchange element in the present invention;

FIG. 5 is a reference view showing the operating state of a heat exchange element in the present invention; and

FIG. 6 is a reference view showing the dust removal mechanism of a heat exchange element in the present invention.

### BEST MODE

Hereinafter, embodiments of the present invention will be described in detail with reference to the accompanying drawings so that those having ordinary skill in the art to which the present invention pertains can easily practice the present invention. However, the present invention may be implemented in various different forms and is not limited to the embodiments described herein. The technical terms used herein are intended only to refer to specific embodiments, but are not intended to limit the present invention. Furthermore, the singular forms used herein include the plural forms unless the phrases clearly indicate the opposite. The meaning of “including” used herein specifies one or more specific characteristics, regions, integers, steps, operations, elements, and/or components, and does not exclude the presence or addition of one or more other specific characteristics, regions, integers, steps, operations, elements, components, and/or groups. Unless otherwise defined, all terms including technical and scientific terms used herein have the same meanings as generally understood by those having ordinary skill in the art to which the present invention pertains. The terms defined in commonly used dictionaries are additionally interpreted as having meanings consistent with the relevant technical literature and the present disclosure, and are not to be construed as having ideal or formal meanings unless otherwise defined.

The embodiments of the invention described with reference to the perspective drawings specifically illustrate ideal embodiments of the invention. As a result, various modifications of the illustrations, such as modifications in manufacturing methods and/or specifications, are expected. Accordingly, the embodiments are not limited to the specific shapes of the regions depicted, but also include modifications of the shapes due to manufacturing, for example. For example, the regions depicted or described as being flat may generally have rough characteristics/rough and non-linear characteristics. Furthermore, the portions depicted as having sharp angles may be rounded. Therefore, the regions depicted in the drawings are only approximate in nature, and their shapes are not intended to depict the exact shapes of the regions, nor are they intended to narrow the scope of the invention.

### MODE FOR INVENTION

Hereinafter, preferred embodiments of an air circulating device having a heat exchange element for dust collection according to the present invention will be described in detail with reference to the accompanying drawings.

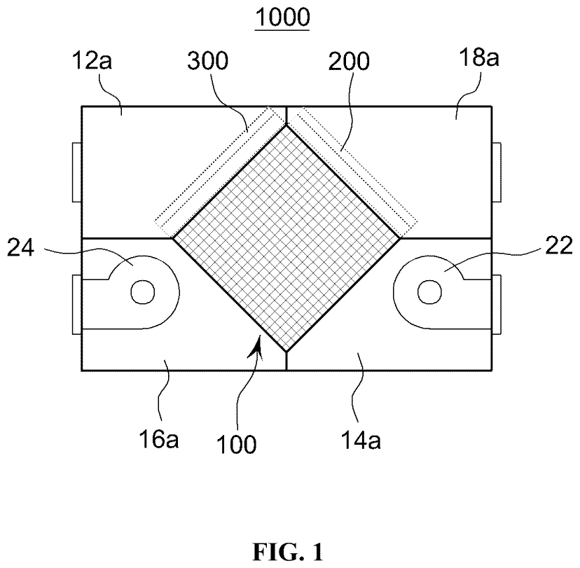

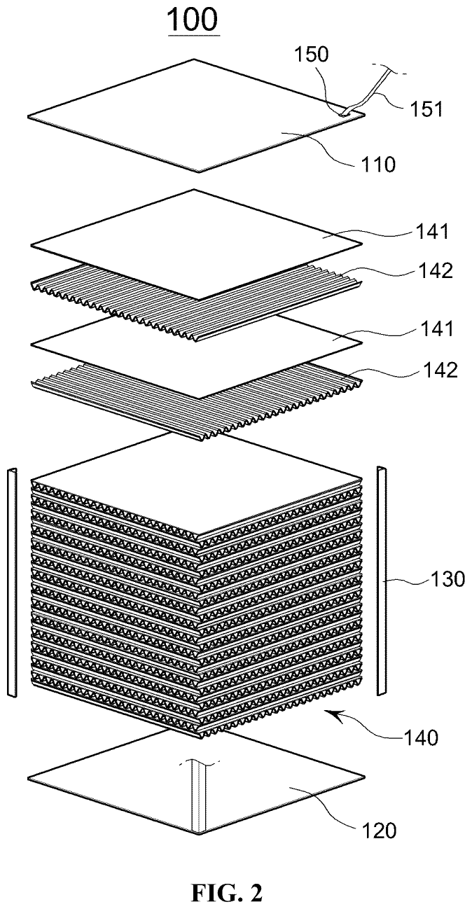

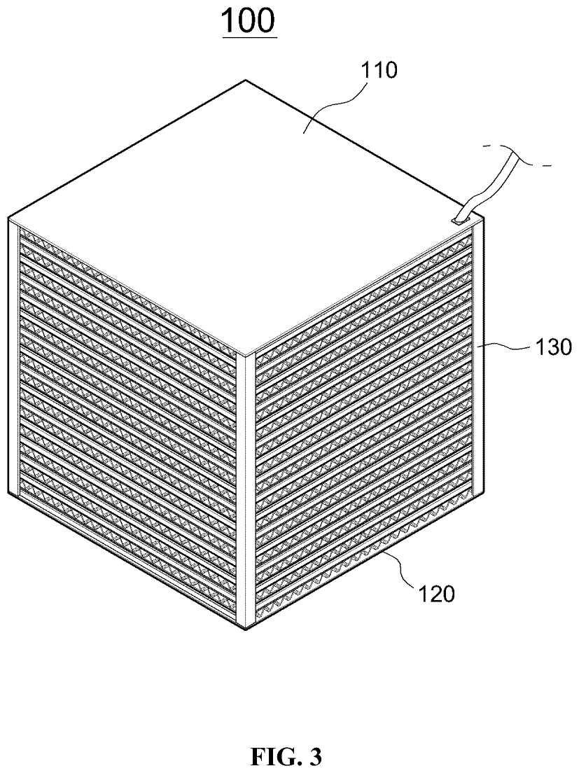

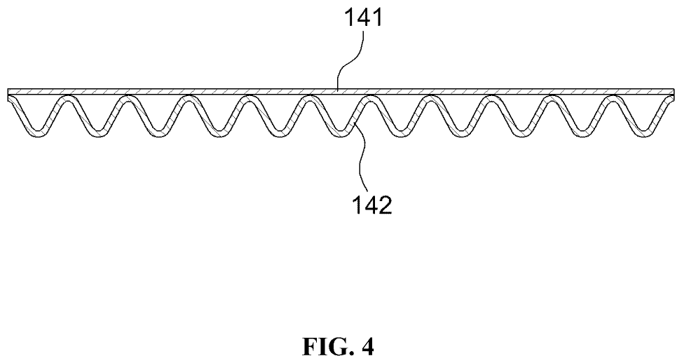

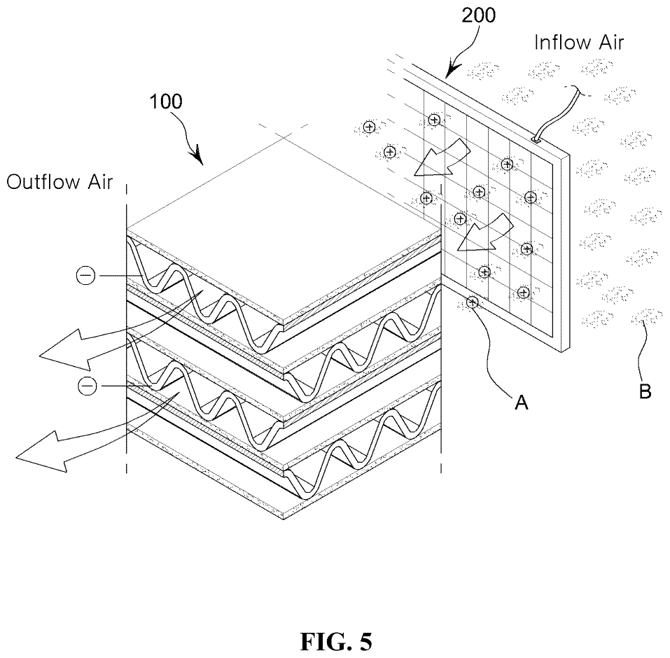

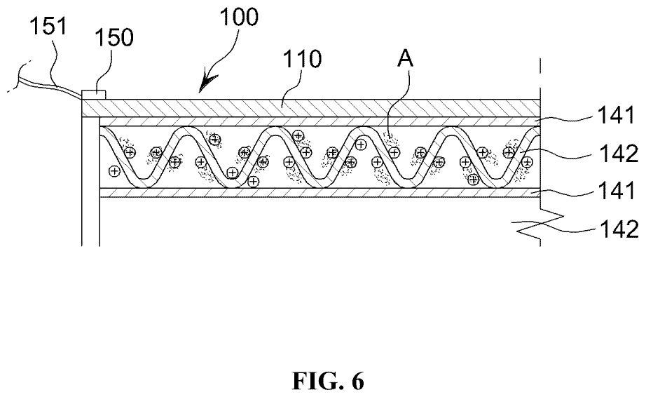

FIG. 1 is a sectional view of an air circulating device according to an embodiment of the present invention, FIG. 2 is an exploded perspective view of a heat exchange element in the present invention, FIG. 3 is an assembled perspective view of FIG. 2, FIG. 4 is a sectional view showing the structures of the heat transfer plate and spacer of a heat exchange element in the present invention, FIG. 5 is a reference view showing the operating state of a heat exchange element in the present invention, and FIG. 6 is a reference view showing the dust removal mechanism of a heat exchange element in the present invention.

First, it should be noted that throughout the drawings, the same components or parts are denoted by the same reference numerals as much as possible. Furthermore, in the following description of the present invention, specific descriptions of related well-known functions or components will be omitted in order to prevent the gist of the present invention from being obscured.

The air circulating device 1000 of the present invention has a heat exchange element 100 therein, and includes a case that is partitioned into an outdoor air inflow space 12a, an indoor air discharge space 14a, an outdoor air discharge space 16a, and an indoor air inflow space 18a centered on the heat exchange element. In this case, blowers 22 and 24 may be included in the case.

The above heat exchange element 100 is formed in a structure in which heat transfer plates 141 and spacers 142 are alternately stacked on top of each other. The spacers 142 are respectively arranged in the spaces between the plurality of heat transfer plates 141, and have a structure in which the plurality of spacers 142 are repeatedly arranged in a perpendicular manner so that air paths can be formed in directions perpendicular to each other.

The above-described heat transfer plates 141 have flat shapes, and the spacers 142 have corrugated sectional shapes. The reason for this is that heat exchange needs to occur through the heat transfer plates 141 and air needs to flow through the spacers 142.

In this case, the heat transfer plates 141 or spacers 142 of the heat exchanger 100 are made of metal or a conductive material and electrically connected to the upper plate 110 or lower plate 120 and frames 130 of the heat exchanger 100. This is intended to allow neutral or ionized dust in the air to be collected by the heat transfer plates 141 or spacers 142.

Accordingly, the heat transfer plates 141 or spacers 142 need to be electrically conductive. In order to make them all conductive, they need to come into contact with the frames 130 that support the corner sides of the heating plates 141 and the spacers 142.

Furthermore, the frames 130 are in contact with a top plate 110 or a bottom plate 120 configured to support the heat transfer plates 141 and the spacers 142 from the top and bottom sides, so that even when an electrode 150 is connected to only one of the top plate 110 or the bottom plate 120, electricity can be conducted to all the frames 130, the heat transfer plates 141, and the spacers 142.

Furthermore, in the present invention, a charge generator 200 configured to conduct charges to dust may be formed on one side of the heat exchange element 100. The reason for this is to apply strong charges to dust so that the dust can more easily stick to the heat transfer plates 141 or spacers 142.

In this case, fine dust in the air usually carries positive ions, so that it is desirable to connect a positive electrode to the charge generator 200 and connect a negative electrode 150 to the top or bottom plate 110 or 120 and frames 130 of the heat exchange element 100 so that negative charges are conducted. In this case, an electric wire 151 is connected to the electrode 150 to supply electricity.

In this manner, outdoor dust B is in the state of being positively charged as it passes through the charge generator 200, and the heating plates 141 or spacers 142 are in the state of being negatively charged, so that charged dust A naturally sticks to the heating plates 141 or spacers 142 while passing through the heating plates 141 or spacers 142.

Accordingly, even the ultrafine dust that has passed through a filter (not shown) installed on a side of the heat exchange element 100 is filtered once more by the heat exchange element 100, i.e., the heat transfer plates 141 or spacers 142.

The dust attached to the heat transfer plates 141 or spacers 142 of the above heat exchange element 100 may be removed later through a reverse washing process, i.e., a process of blowing high pressure air in the direction opposite to the inlet direction.

As described above, although the present invention has been described by the limited embodiments, the present invention is not limited thereto, and various modifications and variations may be made within the scope of the technical spirit of the present invention and the equivalent scope of the patent claims to be described below by those having ordinary skill in the art to which the present invention pertains.

### DESCRIPTION OF REFERENCE NUMERALS

1000: air circulating device of the present invention
100: heat exchange element
110: top plate
120: bottom plate
130: frames
140: stacked heat transfer plates and spacers
141: heat transfer plate
142: spacer
150: electrode
151: electric wire
200, 300: charge generator
A: outdoor dust
B: charged dust

1. An air circulating device having a heat exchange element for dust collection, the air circulating device having the heat exchange element therein and comprising a case that is divided into an outdoor air inflow space, an indoor air discharge space, an outdoor air discharge space, and an indoor air inflow space centered on the heat exchange element, in which the heat exchange element is formed in a structure in which heat transfer plates or spacers are stacked on top of each other, the spacers are repeatedly arranged between the plurality of heat transfer plates so that air paths can be formed, the heat transfer plates or spacers are made of a conductive material and electrically connected to each other, a top plate is formed on a top of the heat exchange element formed in such a manner that the plurality of heat transfer plates or spacers are stacked and a bottom plate is formed on a bottom of the heat exchange element, and an electrode is connected to at least any one of the top or bottom plate and frames;
wherein at least two sides of the top and bottom plates and the heat transfer plates or spacers are supported by the frames made of a conductive material;
wherein the top and bottom plates, the heat transfer plates or spacers, and the frames are also made of a conductive material;
wherein sides or corners of all the heat transfer plates or spacers are brought into contact with the frames;
wherein a charge generator is provided on one side of the heat exchange element; and
wherein an electrode opposite to an electrode connected to the charge generator is connected to the top or bottom plate and frames of the heat exchange element.
